(19) United States
(12) Patent Application Publication
(10) Pub. No.: US 2019/0226265 A1
(43) Pub. Date: Jul. 25, 2019

(54) Child-Safe Automatic Doors

(71) Applicant: Cehan Ahmad, Mayfield Heights, OH (US)

(72) Inventor: Cehan Ahmad, Mayfield Heights, OH (US)

(21) Appl. No.: 16/245,461

(22) Filed: Jan. 11, 2019

Related U.S. Application Data
(60) Provisional application No. 62/619,445, filed on Jan. 19, 2018.

(51) Int. Cl. E05F 15/73; E05F 15/75; G05B 19/416

(52) U.S. Cl. CPC E05F 15/73; E05F 15/75; G05B 2219/40062; E05Y 2900/132; G05B 19/416

(57) ABSTRACT

An automatic door that senses small children to avoid automatically opening the door for the detected children. Various embodiments use one or more sensors that might include proximity sensors, weight sensors, height sensors, and facial recognition sensors, for example. Logic processing is used to evaluate the outputs of the sensors to determine whether a person is a child or an adult, and the door is controlled accordingly.

### CROSS-REFERENCES TO RELATED APPLICATIONS

This application claims the benefit of U.S. Provisional Patent Application Ser. No. 62/619,445 filed on Jan. 19, 2018, and incorporated herein by reference in its entirety.

### BACKGROUND

Automatic doors as currently implemented often work with infrared sensors, pressure switches, and/or motion sensors. These doors open for any person or other object that is moved into their field of operation. This means that doors are opened for even young children, who should not be wandering about alone. Absent from the market is a “child-safe” automatic door which uses methods to differentiate children from adults, so that the automated doors will, in at least some circumstances, not open for small children to avoid letting them wander away from their parents and/or enter unauthorized areas.

### SUMMARY

Some embodiments of the invention use a number of sensors in a novel way for identifying children and preventing the door from opening. These sensors may include weight, height, light and PIR (Passive Infrared) sensors, and also facial recognition or other biometric identification or differentiation, in order to differentiate small children from other people in automatically opening doors.

Provided are a plurality of example embodiments, including, but not limited to, a method of differentiating between an adult and a child for automatically opening a door, comprising the steps of:
detecting the presence of a person near the door;
sensing one or more personal parameters from the person near the door;
evaluating the one or more personal parameters to determine whether the person near the door is a child that is below a particular age; and
automatically opening the door if the person near the door is determined to not be a child below the particular age but not opening the door if the person is determined to be a child below the particular age.

Also provided is a method of differentiating between an adult and a child for automatically opening a door, comprising the steps of:
detecting the presence of a person near the door;
sensing at least two personal parameters from the person near the door;
evaluating both of the personal parameters to determine whether the person near the door is a child that is below a particular age; and
automatically opening the door if the person near the door is determined to not be a child below the particular age but not opening the door if the person is determined to be a child below the particular age.

Further provided is a method of differentiating between an adult and a child for automatically opening a door, comprising the steps of:
detecting the presence of a person near the door;
sensing a first personal parameter from the person near the door using a first sensor;
sensing a second personal parameter from the person near the door using a second sensor;
evaluating, by executing software stored on a computer system, both the first personal parameter and the second personal parameter to determine whether the person near the door is a child that is below a particular age; and
automatically opening the door if the person near the door is determined to not be a child below the particular age but not opening the door if the person is determined to be a child below the particular age.

Still further provided is a system for performing any of the disclosed methods, said system comprising a door, door controller, at least one sensor, and control logic for determining whether to open the door based on input from the sensor(s) used to determine whether a person is a child or adult before automatically opening door.

Also provided are additional example embodiments, some, but not all of which, are described herein below in more detail.

### BRIEF DESCRIPTION OF THE DRAWINGS

The features and advantages of the example embodiments described herein will become apparent to those skilled in the art to which this disclosure relates upon reading the following description, with reference to the accompanying drawings, in which:

FIG. 1a is a block diagram representing an example embodiment of a Child Safe Automatic Door using weight sensors;

FIG. 1b is a block diagram representing an example embodiment of a Child Safe Automatic Door using weight sensors and a wireless transmitter and a wireless receiver’

FIG. 2a is a block diagram representing an example embodiment of a Child Safe Automatic Door using combination weight sensors, height sensors and face recognition;

FIG. 2b is a block diagram representing an example embodiment of a Child Safe Automatic Door using combination weight sensors, height sensors and face recognition and wireless transmitter and receiver;

FIG. 3a is a block diagram representing an example embodiment of a Child Safe Automatic Door using weight sensors and height sensors;

FIG. 3b is a block diagram representing an example embodiment of a Child Safe Automatic Door using weight sensors and height sensors and a wireless transmitter and receiver;

FIG. 4 is a schematic drawing of an example door system for implementing one or more of the example embodiments; and

FIG. 5 is a schematic drawing of a door opening system using a computer system for implementing one or more of the example embodiments.

### DETAILED DESCRIPTION OF THE EXAMPLE EMBODIMENTS

This invention in its various example embodiments relates to child safety around automatic doors. The improved door system is controlled to not automatically open for small children, such as toddlers, babies, pre-school kids, and also pets. This invention can be installed in libraries, shopping malls, children venues like play arenas, stores including retailers like Target, Walmart and other public buildings. The door can even be installed in a private home or office, if desired. This automatic door system is designed to help make stores and public buildings safer for small children.

Provided is an automatic door that senses small children to avoid automatically opening the door for them. Various embodiments of the invention use combinations of weight sensors, height sensors, and facial recognition, for example. Various embodiments may also use a combination of weight sensors and height sensors or a combination of a weight sensor, height sensor, and facial recognition, and other combinations of sensors. The sensors are used to determine whether a person in the vicinity of the door is a small child or not, and an automatic door is operated accordingly through the use of a logic circuit or a programmed controller, or both.

In one embodiment, only a weight sensor is used, in which case the door will be provided with a platform with weight sensors flush in the floor in front of the door exit, which will detect (perhaps approximately) the weight of the object on the sensor, and that weight can be transmitted to a computer system which will determine if the weight is the more than a threshold weight parameter to send a pulse to activate and open the door. If the detected weight is less than the cut off weight, the sensor will give no output, therefore the door will not open. The cut-off weight can be programmed in the system which will be the desired weight of a small child that shouldn't be let out the door. The weight threshold parameter for weight might be adjustable to account for different types of situations, and different ages of children.

Another embodiment may use a height sensor, in which case the sensor will scan a person to detect the height of the person, to detect if the height is sufficient to assume the person is not a small child, and thereby open the door. Typically, a height parameter will be used that represents a typical height of a small child around 4 years old (or another age, if desired). If the computer system detects a person at or above the height parameter threshold setting, it will give an output and let the system function to open the door. The system will not open the door for anybody below that height, therefore the door will not automatically open for small children. Alternatively, the system may just detect persons above a certain height, and not detect persons below that height, rather than measuring the height of a person, but operation will be similar in that the door is automatically opened only for persons above a certain height. The height threshold parameter for weight might be adjustable to account for different types of situations, and different ages of children. This adjustment might be done by raising or lowering a height detector, or entering a height parameter for a sensor that detects an actual height.

In another embodiment using facial recognition, a detection device (which may include a video camera), is placed in front of the exit near the door to detect the face, and/or other features, of a person desiring exit from the door. The facial recognition system will use a computer system to classify the traits of the detected person to determine if the person is a child or adult. It the person is determined as being a child, then it will not open the door, but if the person is classified as an adult, then it will trigger the door system to open the door. Since this system can detect features that differentiate children from adults that aren't merely related to height or weight, it may be able to better differentiate adults of smaller stature from similarly sized children. Again, parameters may be adjustable to change the assumed age of the child for which the door will open or not.

Other embodiments can use a combination of 2 or more types of sensors and detections methods, to determine whether to open the door based on a combination of criteria. Such as system will likely better differentiate a child from an adult than systems using only one type of sensor.

In line with the above discussion, approaches to providing door opening differentiation between adults and small children may involve the use of one or more sensors, which may include weight, height, light and/or PIR (Passive Infrared) sensors, and also facial recognition or other biometric identification or differentiation. These sensors are discussed in more detail in the following paragraphs:

Passive Infrared Sensor (PIR): This sensor is a modern sensor that detects body heat and can be used to determine if that heat source is moving, in which case it can and have the controller give the pulse to the drive system making the drive system go into action. Some embodiments of the invention use a PIR sensor outside the building at entrances like regular automatic doors to add additional functionality to help identify when a person is at the door;

Height: This sensor is used to detect a certain level of height and can be used to detect if that level has anything that is moving in the area of the scan, which can be used to detect an adult/child and determine whether to open the door. Some embodiments of the invention such a sensor installed to detect a maximum height of, for example, a 4-year-old child to detect that it is a child at the door. It might also detect a child so that the system will not let small children through. This sensor can be used along with other sensors to make a very reliable detection. This sensor may be a pass/fail sensor that just detects when a person above a certain height is present, or it may measure the actual or approximate height of the person. This sensor may be made adjustable;

Weight: This sensor, which may be a load cell or some other type of sensor, will detect the actual or approximate weight of the person on the weight sensors set in a platform, such as flush with the floor. After finding the person's weight, the weight can used to determine if the weight reaches a cutoff of, for example, of 40 pounds (average weight of a 4 year old child) or roughly 18 kilograms. Other weight thresholds could be chosen. If it detects a weight above the threshold, it will let the door open. If the detected weight is less than the cut off weight, the door will not open. This sensor may be made adjustable;

Facial Recognition: This sensor, such as a camera, can detect a face that is in front of the door, and in some cases other visual features. It will then use facial features and/or other visual features to help determine the age of the person, such as looking at the roughness of the skin, for example, to determine a potential age of then person (or an age threshold). Other features that may be evaluated include clothing style, hair style, presence of facial hair or makeup, whether the person is carrying a toy, etc. If the person is determined to be above a certain age based on the visual information, the door can be opened. In contrast, if the being on the door is below a certain age (e.g., has smooth skin), it will classify the person as a child and not open the door. Some embodiments of the invention can use facial recognition to aid the system in its desired operation. Note that which visual features are used by a particular system may be made selectable by a user/installer.

Combinations of sensors: A plurality of sensors that function as described above can be utilized in any combination to provide a higher confidence of detecting a child or adult when used in combination.

Note that the door function can be controlled through the use of simple logic circuits, by examining a binary output (e.g., 0/1, yes/no, or pass/fail) to determine whether to open a door or not. If a single sensor type is utilized, then the output can be used more directly to control the door, but if a multiplicity of sensors is used, a logic circuit can be used to open the door when the desired combination of sensors detect a child. Alternatively, a programmable processor can be used to monitor the inputs of the sensors and then make a more complicated analysis to determine whether the person is a child or adult, at a higher confidence level. When more ambiguous results occur, such as some sensors implying the person is a small child, while others do not, the system might be programmed to either open, or not open, the door in such situations, and this may be made a selectable parameter.

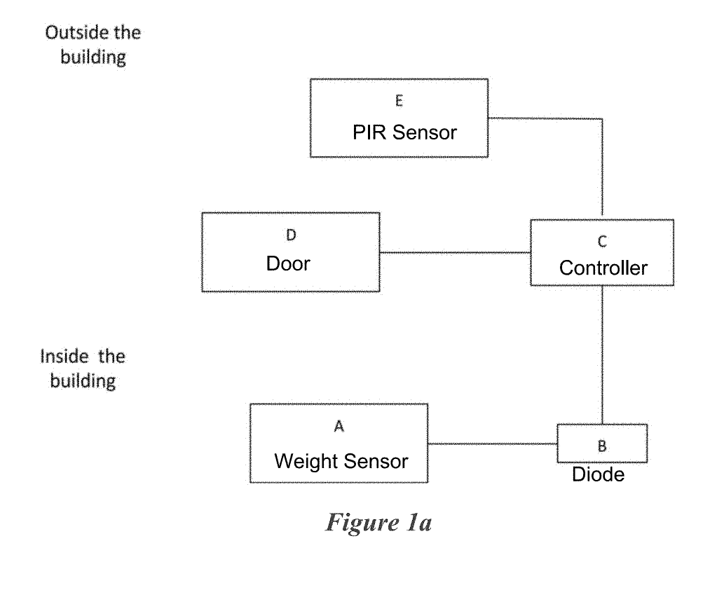

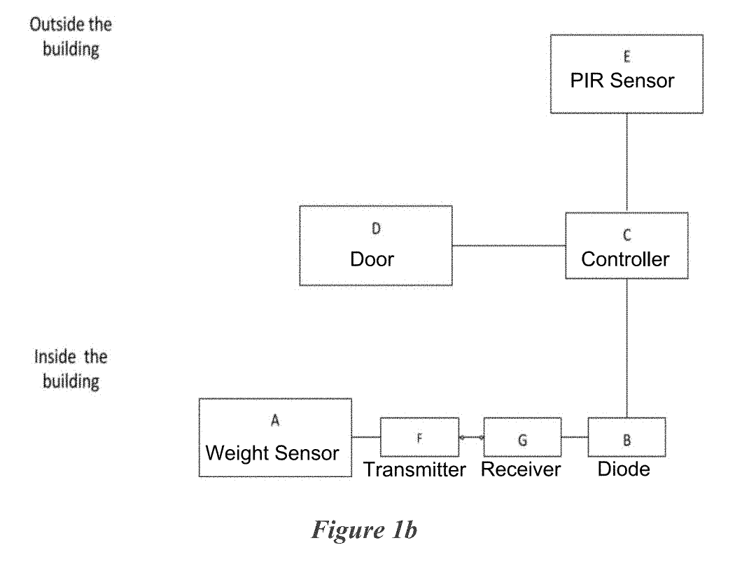

FIGS. 1a, 1b, 2a, 2b, 3a, and 3b all show block diagrams for implementing the various logic circuits using combinations of the sensors, where the blocks represent the following components and sensors:

A is a weight sensor which will measure the weight of a person standing on it and make it into a number for the diode; B is a diode that is given output by the weight sensor; C is a controller for the door, which will determine the time the door remains open and the delay for the door to open and that will also tell the door when to open; D is the door, which is told to open by the controller or the system when an adult at the door; E is a Passive Infrared Sensor (PIR) that is used on the outside of the door, which will send a signal for the door controller to open from the inside; F is a transmitter that is placed next to the weight sensor underneath the mat; G is a receiver that is used to receive the signals sent by the transmitter; H is a height sensor which will make a scan at a certain y-coordinate, and then, if it detects something, it will send an output to one of the 2 logic gates; I is a first type of “logic gate” that implements logic based on the facial recognition, weight, and height sensors; J is a Facial Recognition sensor (e.g., camera), which will determine if the person standing in front of the door is a child or an adult by assessing makeup and the amount of roughness in the skin; K is a second type of “logic gate” that implements logic based on the weight and height sensors; and L is a programmable processor that is programmed to determine whether the face is a child or adult.

FIG. 1a is a block diagram of a first embodiment of the invention in its most simple form. This embodiment uses only a weight sensor A and no transmitter or receiver system. Instead, this embodiment uses a wire that goes through the wall to link the weight sensor A and the diode B, and it operates as follows:

A person is detected to be present by the PIR sensor, which activates the door controller C and overall system. Then, the weight sensor A detects the weight of a person, which can be associated with a number (or logic), this number will be transmitted to the diode B which will do some simple math to find out if this number is greater than 40 pounds which is the average weight of a 4 year old. If it is, then the output is 1 and the controller C will open the door D, if the weight is not Less than or equal to 40 pounds, the output will be zero and the Controller C will not open the door D.

FIG. 1b shows a second embodiment in the form of only using a weight sensor A and instead of using a wire through the wall to connect the weight sensor and the diode, it uses a transmitter F and receiver G system. The transmitter F can be located underneath a door mat, next to the weight sensor A. The mat is embedded with the floor, so nothing can lift the mat and go underneath it. The receiver G is located inside the header of the door D, along with all of the other electronics of the controller C. This system works in the following way:

A person is detected to be present by the PIR sensor, which activates the door controller C and overall system. The weight sensor A will detect a person's weight and associate it with a number, this number will be transmitted to the diode B by the transmitter F and receiver G, which will do some simple math to find out if this number is greater than a threshold, e.g., 40 pounds which is the average weight of a 4 year old. If it is, then the output is 1 and the controller C will open the door D, if the weight is not Less than or equal to 40 pounds, the output will be zero and the controller C will not open the door D.

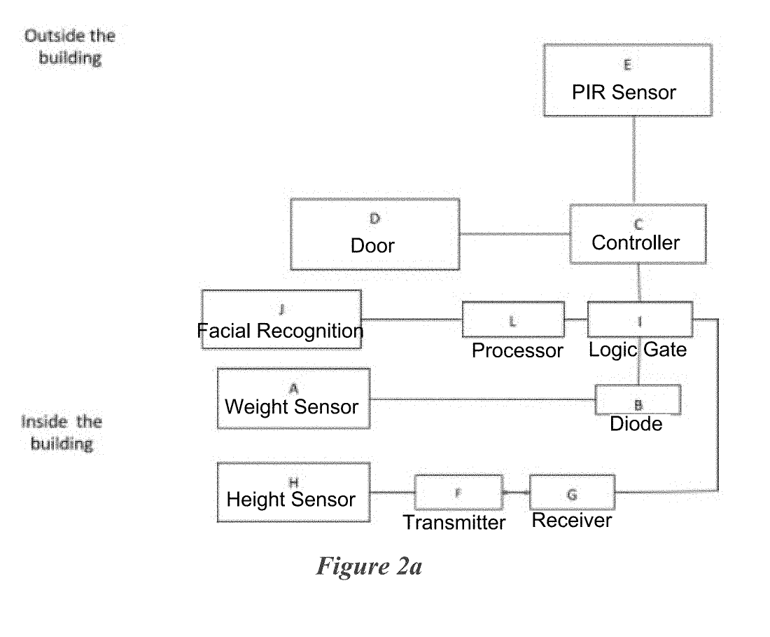

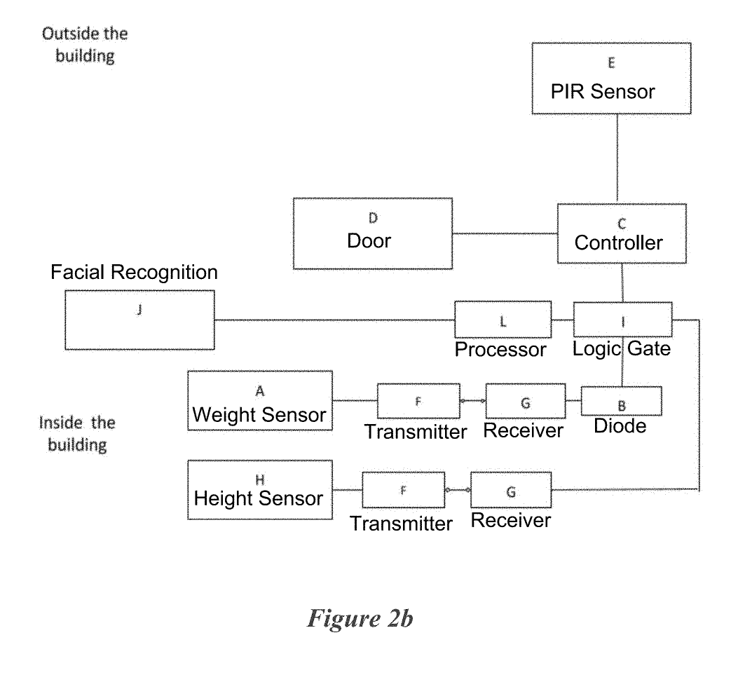

FIG. 2a shows a third embodiment, which uses all of the three following sensors, height H, weight D, and facial recognition J. This embodiment does not contain a transmitter and receiver system.

A person is detected to be present by the PIR sensor, which activates the door controller C and overall system. The weight sensor A detects the weight of the person standing upon it, then, it transmits that signal, in this case it uses a wire. It will then give that signal to a diode B which will determine whether the output is 1 or 0. If it is one then that goes into a “logic gate” I. The input/output chart for this “logic gate” is in Table 1, below. The height sensor H will determine if there is an object as tall as its height setpoint, if there is, it gives and output of 1, and if there isn't, then it will give an output of 0. It does this, for example, by making an infrared scan, but only at a certain y-coordinate, if it detects something on that specific y-coordinate, then it will give an output of 1, and if it doesn't, it will give an output of 0. The height sensor H can send its output to the logic gate I using transmitter F and receiver G.

The facial recognition system J will transmit an image of this face through binary to a processor L. This processor L will then get the image back into the form of a picture and determine if the image displayed to it is a child or an adult, for example by assessing the amount of roughness in the skin. If there is sufficient roughness, then the output will come out as 1. If there is not enough roughness, then the output will come out as 0. All three of the results will then be assessed by the “logic gate” I and have the controller C control the door. If the output ends out as 1, then the controller C will open the door D, and if the output is 0, then the controller C will not open the door D.

TABLE 1

| Weight | Height | Facial Recognition | Output |
|---|---|---|---|
| 1 | 0 | 0 | 0 |
| 1 | 1 | 0 | 1 |
| 0 | 0 | 0 | 0 |
| 1 | 1 | 1 | 1 |
| 0 | 1 | 0 | 0 |
| 1 | 0 | 1 | 1 |
| 0 | 0 | 1 | 0 |
| 0 | 1 | 1 | 0 |

Table 1, above, is the table that can be used for the “logic gate” I, which can be used for the embodiments shown in FIGS. 2a and 2b. This “logic gate” need not be implemented in actual logic circuits, but can be implemented in an actual system from diodes, or by using a programmable controller. Basically, if the output for the given sensor, (either height, weight or facial recognition) is either 1 or 0 and the output for the other 2 sensors is either 1 or 0 (separately), and all of the combinations will produce an output of 1 or 0. An output of 0 represents detection of a value that represents a small child, and a 1 represents not detecting a small child. Hence, when the resulting output is 0, the door is prevented from opening, but it is opened for a 1. Other logic solutions can be utilized, as desired, and may be provided as an adjustable parameter.

FIG. 2b shows a fourth embodiment which uses the same three sensors as the third embodiment, height H, weight A, and facial recognition J. This contains two transmitter F and receiver G systems.

A person is detected to be present by the PIR sensor, which activates the door controller C and overall system. The weight sensor A detects the weight of the person standing upon it, and it transmits the weight signal using a first transmitter F to a first receiver G then lets it give that signal to a diode B which will determine whether the output is 1 or 0. If it is one then that goes into a “logic gate” I. The input/output chart for this “logic gate” is in Table 1, above. The height sensor H will determine if there is an object as tall as its height setpoint, if there is, it gives and output of 1, and if there isn't, then it will give an output of 0, by making an infrared scan, but only at a certain y-coordinate, if it detects something on that specific y-coordinate, then it will give an output of 1, and if it doesn't, it will give an output of 0.

The facial recognition system J transmit an image of the person's face through binary to processor L (this does not use any transmitter or receiver system in this example, but it could as an alternative). This processor L will then get the image back into the form of a picture and determine if the image displayed to it is a child or an adult purely by assessing the roughness of in the skin. If there is enough roughness, then the output will come out as 1. If there is not enough roughness, then the output will come out as 0. All three of the results will then be assessed by the “logic gate” I and the door controller C will control the operation of the door D. If the output is 1, then the door controller C will open the door D, and if the output is 0, then the door controller C will not open the door D.

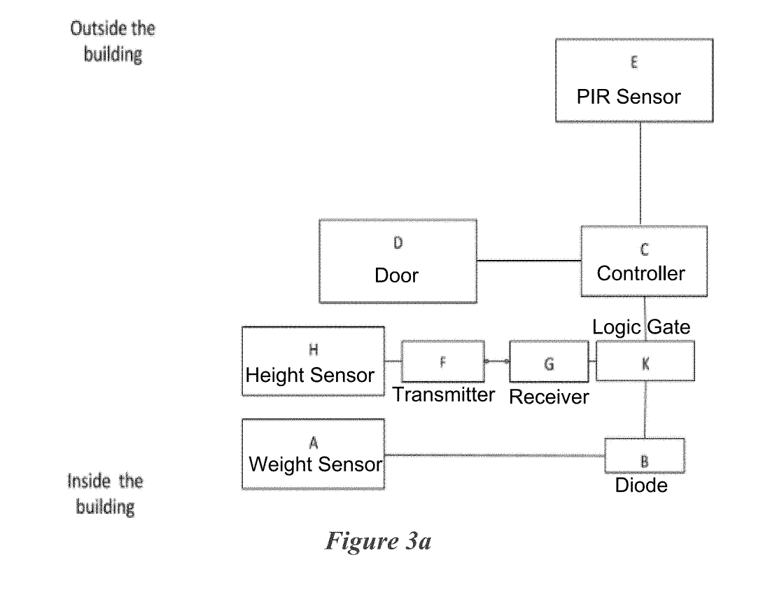

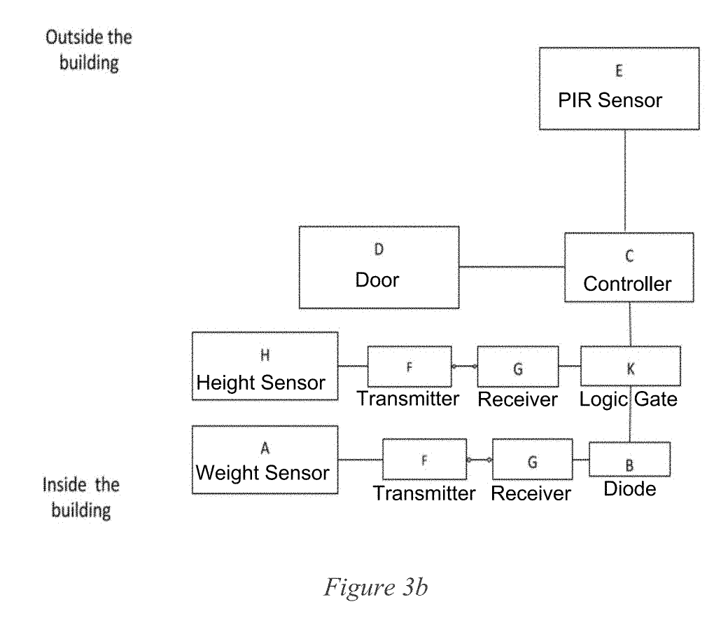

FIG. 3a, is a block diagram of a fifth embodiment of the invention, using both a weight and a height sensor, which does not use a transmitter and receiver system, and which works very similarly to the third embodiment of FIG. 2a.

A person is detected to be present by the PIR sensor, which activates the door controller C and overall system. The weight sensor A detects the weight of the person, transmits it through to the diode B which detects if the weight detected is greater than or less “than/equal to 40 pounds. If it is greater than 40 pounds, then the output is 1 and that is put into a “logic gate” K. The input and output logic for this is provided in Table 3, below. If it is less than or equal to 40 pounds, then the output is 0, this is then put into the “Logic gate” K. The height sensor H will continually be making a scan at a certain y-coordinate, if somebody is detected at this y-coordinate, then it will give an output of 1, if there is nothing detected, then it will give an output of 0. All of the outputs will then be put into the “Logic Gate” K via Transmitter F and receiver G. The controller C will open the door D if the person is determined to be an adult, and not open if the person is determined to be a child.

TABLE 2

| Weight Sensor | Height Sensor | Output |
|---|---|---|
| 1 | 0 | 0 |
| 0 | 1 | 1 |
| 1 | 1 | 1 |
| 0 | 0 | 0 |

Table 2 is the table that might be used for the “logic gate” K, which can be used for the embodiments of FIGS. 3a and 3b. Again, this “logic gate” need not be comprised of logic circuits, but can be comprised of diodes or a programmable controller. Basically, if the output for the given sensor, (either height or weight) is either 1 or 0 and the output for the other sensor is either 1 or 0, and all of the combinations will produce an output of 1 or 0. The values can represent situations as discussed under Table 1.

FIG. 3b shows a sixth embodiment of the invention using weight sensors and height sensors, including the use of transmitters and receivers.

A person is detected to be present by the PIR sensor, which activates the door controller C and overall system. The weight sensor A detects the weight of a person, and associates it with a number, let's call it x, this is then given to the first transmitter F which will send a signal to the first receiver G what the weight was, the receiver G, located in the header of the door D, gives the value to the diode B, the diode will then determine whether the weight put on top of x is greater than or less than/equal to 40 pounds, if it is greater than 40 pounds then the output is 1, x it is less than or equal to 40 pounds, then the output is 0, regardless of the output, it is then put into a “logic gate” K, the input/output logic for this is in Table 2, above. As for the height sensor H, it will make a scan at a certain y-coordinate, if there is something in the y-coordinate, then it will send an output of 1 to the “logic gate” K via the second transmitter F/Receiver G pair. The controller C will open the door D if the person is determined to be an adult, and not open if the person is determined to be a child.

Any of the disclosed embodiments may utilize a programmable microprocessor for use in implementing the invention. This processor would then be programmed using software instructions that utilize the data provided by the various sensors to control the door function according to the functions described in this document. The processor can be programmed according to any known programming methods using any available programming language to achieve the disclosed objectives. Communication between devices may be by wire, network (e.g., Ethernet), or wireless such as WiFi, Bluetooth, RF, radio, etc.

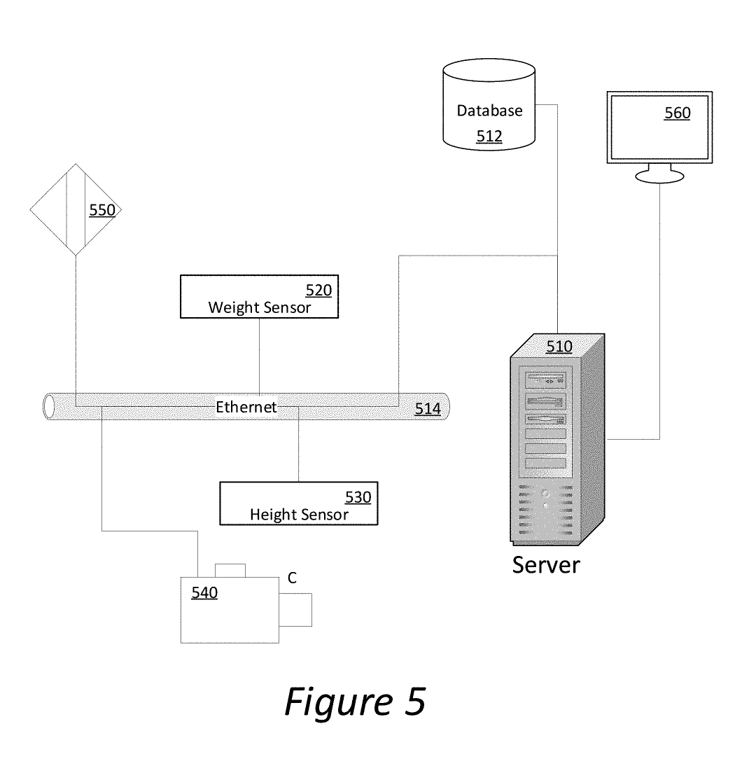

FIG. 5 shows an example embodiment that uses a programmable server 510 accessing a database 512 to monitor a proximity sensor 550, a weight sensor 520, a height sensor 530, and an image sensor 540, all connected to the server 510 via an ethernet network 514. Note that images from the image sensor 540 may be shown on a monitor 560. This system can be programmed to implement the control logic as described in any of the other embodiments discussed above, or it could be programmed for a more complex analysis in order to improve the likelihood of differentiating between a small adult and a child so that adults are not prevented from using the door.

For example, more detailed analysis of the image of the person can be performed using a programmed system, such as by examining the style of clothing, hair style, existence of tattoos, existence of jewelry, existence of facial hair or makeup, an amount of fidgeting, and other potential differentiators between adults and children.

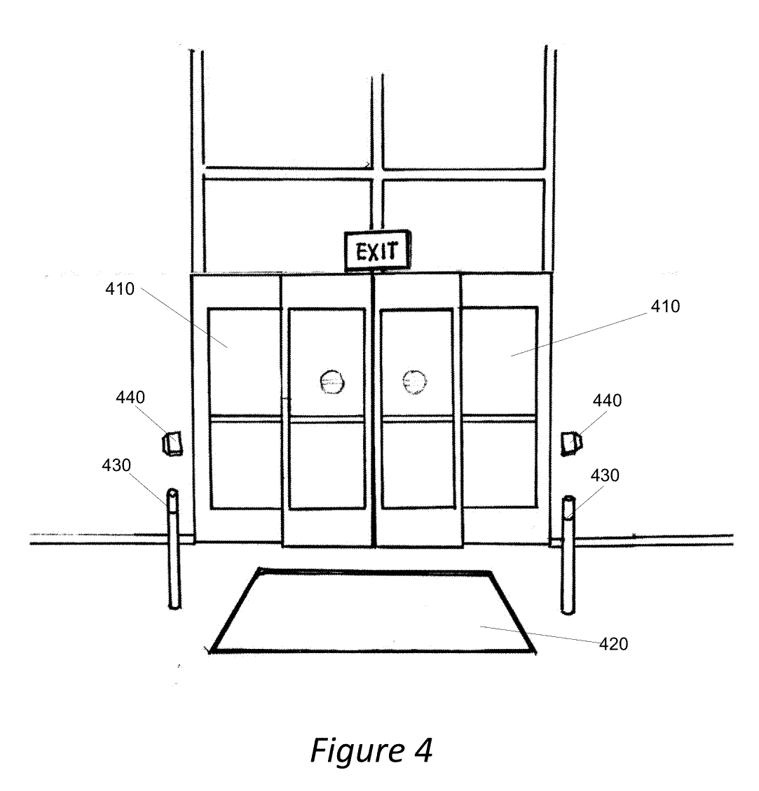

FIG. 4 shows a schematic of an example embodiment as might be implemented in a public place, having a pair of doors 410 with a floor mat 420 comprising one or more weight sensors used to detect an actual weight, or a threshold weight, of a person standing on the mat. A pair of height sensors 430 are provided, for example, on poles near respective doors 410, and are used to detect either an actual height, or a threshold height, of a person standing on the mat 420. A pair of facial recognition sensors 440 (such as cameras) are provided, for example, on a wall near the respective doors 410 to obtain visual information about the person standing on the mat 420. Processing electronics and door opening mechanics (not shown) may be provided in a frame of the door(s) 410 or at another location. The various sensors in this embodiment may communicate with the processing electronics via a wired or wireless connection. This door determines whether a person standing on the mat 410 is a child or not in a manner such as described above in this disclosure.

Alternatively, the methodology might be implemented using hard-wired components, such as analog components, like relays, switches, op-amps, or digital components like comparators and logic circuits, or a combination of analog and digital components, rather than, or in addition to, using programmable processors. Such a system may be simpler in design and less likely to fail, and may need less maintenance, for example.

Many other example embodiments can be provided through various combinations of the above described features. Although the embodiments described hereinabove use specific examples and alternatives, it will be understood by those skilled in the art that various additional alternatives may be used and equivalents may be substituted for elements and/or steps described herein, without necessarily deviating from the intended scope of the application. Modifications may be necessary to adapt the embodiments to a particular situation or to particular needs without departing from the intended scope of the application. It is intended that the application not be limited to the particular example implementations and example embodiments described herein, but that the claims be given their broadest reasonable interpretation to cover all novel and non-obvious embodiments, literal or equivalent, disclosed or not, covered thereby.

What is claimed is:

1. A method of differentiating between an adult and a child for automatically opening a door, comprising the steps of:
detecting the presence of a person near the door;
sensing one or more personal parameters from the person near the door;
evaluating the one or more personal parameters to determine whether the person near the door is a child that is below a particular age; and
automatically opening the door if the person near the door is determined to not be a child below the particular age but not opening the door if the person is determined to be a child below the particular age.

2. The method of claim 1, wherein said one or more personal parameters include a detected height of the person.

3. The method of claim 1, wherein said one or more personal parameters include a detected weight of the person.

4. The method of claim 1, wherein said one or more personal parameters include a detected feature of the face of the person.

5. The method of claim 4, wherein said detected feature of the face of the person is a smoothness or roughness of the face of the person.

6. The method of claim 4, wherein said detected feature of the face of the person is the existence of facial hair on the face of the person.

7. The method of claim 4, wherein said detected feature of the face of the person is the existence of jewelry on the face of the person.

8. The method of claim 4, wherein said one or more personal parameters also include a detected weight and a detected height of the person, wherein the step of evaluating the one or more personal parameters includes evaluating all of the detected weight, the detected height, and the detected feature of the face of the person.

9. The method of claim 8, wherein said detected feature of the face of the person is a smoothness or roughness of the face of the person.

10. The method of claim 1, wherein said one or more personal parameters include a detected weight and a detected height of the person.

11. A method of differentiating between an adult and a child for automatically opening a door, comprising the steps of:
detecting the presence of a person near the door;
sensing at least two personal parameters from the person near the door;
evaluating both of the personal parameters to determine whether the person near the door is a child that is below a particular age; and
automatically opening the door if the person near the door is determined to not be a child below the particular age but not opening the door if the person is determined to be a child below the particular age.

12. The method of claim 11, wherein said at least two personal parameters include a detected height of the person.

13. The method of claim 11, wherein said at least two personal parameters include a detected weight of the person.

14. The method of claim 11, wherein said at least two personal parameters include a detected feature of the face of the person.

15. The method of claim 14, wherein said detected feature of the face of the person is a smoothness or roughness of the face of the person.

16. The method of claim 14, wherein said detected feature of the face of the person is the existence of facial hair on the face of the person.

17. The method of claim 14, wherein said detected feature of the face of the person is the existence of jewelry on the face of the person.

18. The method of claim 14, wherein said at least two personal parameters also include a detected weight and a detected height of the person, wherein the step of evaluating the one or more personal parameters includes evaluating all of the detected weight, the detected height, and the detected feature of the face of the person.

19. The method of claim 18, wherein said detected feature of the face of the person is a smoothness or roughness of the face of the person.

20. A method of differentiating between an adult and a child for automatically opening a door, comprising the steps of:
detecting the presence of a person near the door;
sensing a first personal parameter from the person near the door using a first sensor;
sensing a second personal parameter from the person near the door using a second sensor;
evaluating, by executing software stored on a computer system, both the first personal parameter and the second personal parameter to determine whether the person near the door is a child that is below a particular age; and
automatically opening the door if the person near the door is determined to not be a child below the particular age but not opening the door if the person is determined to be a child below the particular age.
